(19) United States
(12) Patent Application Publication
(10) Pub. No.: US 2004/0077498 A1
(43) Pub. Date: Apr. 22, 2004

(54) Agricultural seed having protective coatings

(76) Inventor: John F. Lynch, Cuernavaca (MX)

Correspondence Address: BRIAN M BERLINER, ESQ, O'MELVENY & MYERS, LLP, 400 SOUTH HOPE STREET, LOS ANGELES, CA, 90071-2899, US

(21) Appl. No.: 10/610,728

(22) Filed: Jul. 1, 2003

Related U.S. Application Data
(60) Provisional application No. 60/393,153, filed on Jul. 1, 2002.

(51) Int. Cl. A01N 25/26

(52) U.S. Cl. 504/100

(57) ABSTRACT

A seed coating composition is disclosed. The seed coating composition has a first protective polymer film coating, which is non-phytotoxic, maintains oxygen exchange properties, and is hygroscopic. The seed coating composition also has a secondary growth augmentation coating. Also disclosed is a method for coating seeds with a first protective polymer film coating and a secondary growth augmentation coating.

### RELATED APPLICATION

The present application claims benefit of U.S. Provisional Patent Application No. 60/393,153, filed Jul. 1, 2002, which application is hereby incorporated by reference.

### BACKGROUND OF THE INVENTION

1. Field of the Invention

The invention relates to methods of coating seeds first with a protective polymer and second with a nutrient fertilizer or other growth enhancement compounds to increase the frequency of germination, while also providing for the better growth of seedlings due to efficient soil nourishment. The multiple layer approach protects the seeds from environmental exposure, pests, and the osmotic stress of the fertilizer or growth augmentation layer, while increasing plant viability and crop yield, due to the improved fertilization process. Protection as well as enhancement of the growth environment for each seed is achieved. Additional benefits are seen in reduced cost, amount of fertilizer needed, and decrease in undesirable chemical run-off from agricultural fields.

2. Description of Related Art

The agricultural field produces crops of many varieties, including fruits, legumes, lettuce, wheat, barley, corn, and rice, among others. In addition, flower producers and home gardening enthusiasts grow a large variety of plants. Many of these are grown from seeds that vary in their innate ability to resist physical damage due to unfavorable storage or environmental conditions, all of which affects their subsequent ability to grow into adult plants. Seeds are also susceptible to bacterial and fungal damage and are vulnerable to insects, birds, rodents, and other organisms that rely on them as a food source. In addition, seeds can also be adversely affected by fertilizers, pesticides, fungicides, and other nutrients that cause osmotic stress or shock, burning the seeds, and thus reducing viability. The natural seed coat provides some, but often inadequate, protection from these forces.

The efficiency and time of germination are important points that limit the number of seeds that grow into adult plants. Seeds and young seedlings are also dependent on a proper soil environment, which often needs to be supplemented with nutrients or fertilizers, to ensure greater viability and faster growth during this vulnerable phase of development. The nascent seedling is dependant on the uptake of nutrients most of which are absorbed in this early critical phase of growth.

The agricultural industry has undergone what is referred to as a green revolution, resulting in increased crop yields. Current commercial methods of planting rely on preparing the soil with fertilizers consisting mainly of nitrogen, phosphate, and potassium containing compounds, in addition to other secondary nutrients to enhance the soil. Typically, large amounts of fertilizer must be added to a broad area before seeding and then reapplied several weeks later. The green revolution has been possible from the development of high-yield crops that are tolerant to the osmotic stress of higher fertilizer nutrient concentrations. This has led to the increased use of these compounds to promote the more rapid and vigorous growth of crops. It has also allowed increased agricultural output through arability of poorer soil types prone to erosion and agricultural leaching or run-off problems. Similarly, the development of herbicide resistant crop varieties has led to increased use of these compounds as well. Estimates are that use of fertilizer nutrients, herbicides, and like compounds, will continue to dramatically increase. This represents a large agricultural cost that is escalating rapidly. A significant amount of the fertilizer nutrients and like compounds are leached from the soil or lead to agricultural run-off pollutants. This problem is made worse with the high level use of such compounds allowed by modified crop varieties.

These agricultural methods can be prohibitively expensive and the large amounts of fertilizers and like compounds required often lead to undesirable leaching or run-off of primarily nitrogen and phosphorous that are pollutants of the local water table and environment. In particular the cultivation of row crops, as well as other types, results in erosion of the most fertile soil layers. This often elevates the need for more exogenous fertilizers to be used and reduces the natural fertility and recovering ability of the arable land. In addition, the presence of large amounts of excess fertilizer and like compounds in the soil from such conventional soil treatments can also burn newly emerged seedlings, which are more vulnerable than adult plants, via osmotic stress resulting in moisture loss from the plant cells into the soil. Seed coatings that provide fertilizer nutrients and like compounds directly to the seed and seedling allow growth enhancement and also reduced use of these chemicals, less agricultural pollutant runoff, and thus reduced costs. This would benefit all farmers, but especially those not able to support the increased costs associated with high-level fertilizer and herbicide use.

Approaches to coating seeds for their protection and to enhance germination and growth characteristics are well known in the art. There are several basic needs that are met by a wide variety of different seed coatings. Often polymers alone or in combination with natural or other synthetic materials are employed to form the seed coat. A film coating of protective polymeric material and/or additional binder compounds are used to ensure the seeds are evenly coated and that the coating materials stick to each other and to the seed itself. Commonly used film/binders include polyvinyl alcohol and polyvinyl acetate as well as related compounds. Many coatings are single, but additional layers are also known in the art. The polymer coating provides protection from pests and from damage during storage and handling. The coating may be combined with or contain components such as hygroscopic or water repellent agents, pesticides, fungicides, herbicides, hormones, fertilizer nutrients, antibacterial agents, and pigments. These compounds usually aid in germination, prevent disease, and enhance the soil, all of which provide a better growth environment for plant seedlings. Though a wide variety of methods have been developed, many are lacking in efficacy or are designed for a specialized seed type or niche use. An important problem is that the incorporation of primarily fertilizers, but also other nutrients as well as herbicides, fungicides, pesticides, and like compounds, into the coating material can damage the seeds by causing osmotic stress, which can result in moisture leaving the seed resulting in a burned or unviable seed. The osmotic stress can dramatically reduce the numbers of seeds that germinate and grow into adult plants. This increases agricultural costs due to the loss and the need to use excess seed to compensate.

Accordingly, a seed coating is needed that protects the seed from osmotic and other types of damage and that also contains compounds that aid in germination, growth, and soil enhancement. It is desirable that the nutrient chemical compounds would be washed from the seed coating into the soil before the protective layer is removed thus preventing osmotic damage to the seed. This would provide increased fertility of the soil and aid in germination and seedling growth. The amounts of nutrient fertilizers, pesticides, fungicides, herbicides, hormones, and antibacterial agents would be greatly reduced compared to what is needed in conventional agricultural sowing methods that employ these compounds. Such an improved seed coating would increase seed viability, provide cost savings, and lower amounts of agricultural chemicals used. It would also reduce undesirable run-off of primarily nitrogen, phosphorous and potassium compounds, which are the common major agricultural environmental pollutants.

### SUMMARY OF THE INVENTION

The seed coating composition of present invention has a first protective polymer film coating and a secondary growth augmentation coating, in which the first protective polymer film coating is non-phytotoxic, maintains oxygen exchange properties and is hygroscopic. In one embodiment, the first protective polymer film coating may be primary polymers, secondary polymers, plasticizers, binders, surfactants, glidants or pigments or combinations thereof.

In another embodiment, the secondary growth augmentation coating may be primary nutrients, secondary nutrients, hormones, insecticides, pesticides, herbicides, fungicides, bactericides, pigments, binders, surfactants or glidants or combinations thereof.

The present invention also relates to a method of coating seeds with the seed coating composition of the present invention. The method comprises the steps of coating a quantity of seeds with a first protective polymer film coating, allowing the first protective polymer film coating to dry, and coating the quantity of seeds with a secondary growth augmentation coating.

### BRIEF DESCRIPTION OF THE DRAWINGS

FIG. 1 illustrates a representative monocot seed.

FIG. 2 illustrates the seed with a protective polymer-coating layer.

FIG. 3 illustrates the seed with multiple protective polymer coating layers.

FIG. 4 illustrates the seed with a protective polymer coating and a secondary growth enhancement layer.

FIG. 5 illustrates the seed with multiple protective polymer coating layers and a secondary growth enhancement layer.

### DETAILED DESCRIPTION OF THE INVENTION

The invention is related to a multiple layered seed coating that comprises a protective film barrier coating that include cellulose acetate phthalate and like compounds with additional layers containing nutrients and other components necessary for increased germination and improved growth of the developing seedlings. The invention both protects seeds and provides compounds that improve germination, growth, and soil enhancement. The protective coating comprises generally a polymer, solvent, and plasticizer. Other components such as binders, surfactants, fillers, extenders, anti-foaming agents, anti-tack compounds, and pigments may be included as needed.

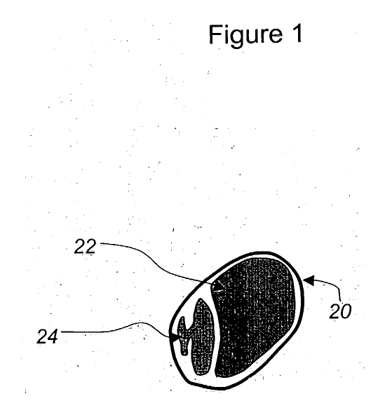

Numerous seed types exist and each varies somewhat in its ability to resist damage from various sources. Referring to FIG. 1, a seed typically includes a seed coat 20 surrounding a dormant embryo 24 and endosperm storage tissue 22. The seed coat 20 also contains pores from which oxygen exchange takes place. This is important for most seed viability, especially during germination. Each seed type is somewhat resistant to osmotic stress, pests, fungal, bacterial infections, and other factors; however, the native protection provided from the seed coat is often inadequate and significant loss can be experienced from seeds that become damaged from these various forces.

In the current invention, the first protective layer 26 comprises a protective polymer of cellulose acetate phthalate (CAP) or similar material, with secondary layers 32 of fertilizer nutrients, hormones, pesticides, herbicides, fungicides, and antibacterial agents to provide for a variety of compounds that increase the germination, viability, and overall growth of new seedling plants. The first polymer CAP coating 26 is non-phytotoxic, maintains oxygen exchange properties, and is also hygroscopic thus aiding in water absorption necessary for successful seed germination. These physical properties of the protective CAP polymer coat 26 allows the secondary coat layers 32 of fertilizer nutrients and like compounds to be washed into the soil to prevent damage to the seed or emerging seedling and also to aid in germination. The compounds in the secondary coat layers 32 either alone or in mixtures provide soil enhancement that increases plant viability and crop yield.

The advantage of having these growth augmentation compounds coated onto the seeds is that this allows significantly less fertilizers and like agents to be used, leading directly to cost savings. In current agricultural practices the fertilizers and herbicides are spread over the entire agricultural field before sowing. Much of the nutrients are not utilized directly and are leached from the soil or washed away as run-off. This is expensive and somewhat inefficient. It is also undesirable due to the contamination of the local environment, rivers, lakes, as well as the extended water table, with nitrogen, phosphorous, and other chemicals. One major problem is that after multiple crop fertilization cycles the soil salinity increases which can dramatically reduce soil fertility. Often this is remedied by rotating crops that require significant amounts water which washes the accumulated salts from the soil. When effusive irrigation or rainfall is utilized to wash the soil to reduce salinity levels, increased levels of erosion are also seen, which also removes vital top soil reducing soil fertility further thus increasing the dependence on fertilizers. With nutrient coated seeds the growth enhancement compounds are directly with the seed effectively giving a high local concentration, but overall lower soil concentration. This is especially beneficial over time since the negative additive effects are significantly less.

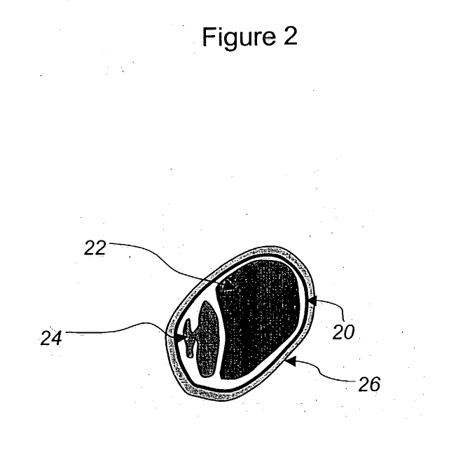

As shown in FIG. 2, the seed is first coated with a polymer of cellulose acetate phthalate or similar compound as protective layer 26. Cellulose acetate is a synthetic polymer, obtained from cellulose by reaction with acetic anhydride, that has intrinsic properties that make it suitable as a protective seed coating. It is highly moldable and has a low solution viscosity. The viscosity can be adjusted based on the degree of polymerization. Commercially available cellulose acetate can vary in the degree of acetylation. Two major types are available including, cellulose triacetate (CTA) that has a degree of acetylation of not less than 59% and cellulose diacetate (CDA) that can vary from approximately 50-59% acetylation. The overall range of acetylation 50-59% can be adjusted during the manufacturing process. The lower ranges of acetylation increase the hygroscopicity of the cellulose acetate while reducing the dimensional stability. A plasticizer such as diethyl phthalate or the like can be added to adjust the physical characteristics of the cellulose acetate to a desired degree of viscosity and strength to form cellulose acetate phthalate (CAP). CAP is used commercially in the pharmaceutical industry as a protective coating for medicines. Various methods of manufacture and techniques for coating, as well as commercial sources, are available and known in the art. These include both wet and dry film polymer-coating procedures. The CAP polymer is ideally suited to be a protective coating of agricultural seeds due to its unique physical properties.

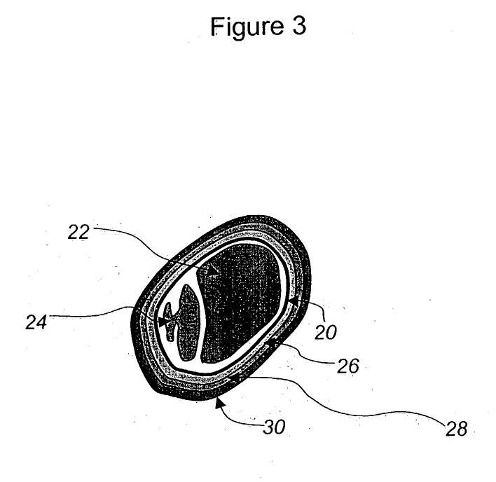

In a preferred embodiment of the invention, as shown in FIG. 2, the CAP seed coating 26 will have characteristics that allow gas exchange from the seed while being strong and protective to prevent osmotic, physical, and environmental damage. It will also have hygroscopic properties that allow the outer layers 32 of fertilizers and other compounds to be washed away with water via natural rainfall or irrigation and then allow the protective coat to dissolve at a slower rate. This protects the seed from osmotic burning from the secondary coating nutrients and like materials, while subsequently allowing the seed to contact the water to induce germination. The nutrients or protective antimicrobial compounds have a resulting higher local concentration in the soil surrounding each seed, thus increases their effectiveness. It also reduces the amounts of these agents that are needed. The hygroscopic properties of the CAP coating 26 will also aid in attracting and holding water essential for germination and growth of the seedling. The CAP polymer layer 26 is ideally suited to dissolve at the higher pH ranges found in many agricultural soils. The thickness and dimension of the CAP coat 26 can be adjusted for individual seed types to provide ideal protective and hygroscopic properties for germination. In a preferred embodiment, as shown in FIG. 3, the protective coat is further comprised of two or more layers 26, 28, 30 of CAP polymer or like material. The kinetics of the protective polymer dissolving when contacted with water can be regulated depending on need by changing the specific composition, thickness, or number of layers. The outer layer 30 would have less hygroscopic character and be more protective, while the layer 26 next to the seed coat would have more hygroscopicity, which attracts and absorbs water to aid in germination. This allows protection to occur until all nutrients and similar compounds are safely dispersed into the soil before the innermost layer 26 attracts water and subsequently dissolves. The CAP coating 26 can also be varied to provide the desired properties of protection, solubility, and hygroscopicity depending on soil characteristics of pH, hydration, and type.

In other embodiments, the CAP polymer can be combined with or replaced by similar derivative polymer compounds modified to increase the binding to specific seed types and to reduce cracking, eliminate bridging, maximize permeability, solubility, and the hygroscopic properties of the protective polymer layer. Candidate protective polymer compounds include but are not limited to, cellulose derivatives such as, hydroxypropylcellulose phthalate, hydroxyethylmethylcellulose phthalate, hydroxypropylmethylcellulose phthalate, hydroxymethycellulose phthalate, carboxymethylcellulose phthalate, and methycellulose phthalate. Other candidate polymer compounds include, but are not limited to, polyvinyl acetate phthalate, ployvinylpyrrolidone, polyvinylmethylethermaleic anhydride copolymer, and other acrylic polymers. In addition, different plasticizers other than phthalate can be used and include, but are not limited to, acetyltriethyl citrate, triethyl citrate, acetyltributyl citrate, dibutylsebacate, triacetin, glyceryl triacetate, polyethylene glycols, propylene glycol, glycerin, and the like. In other embodiments, the plasticizer, such as phthalate, may be absent.

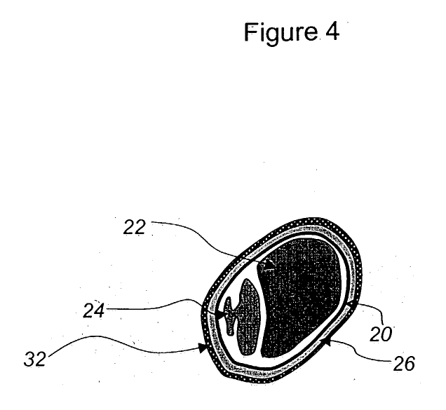

As shown in FIG. 4, the secondary or additional multiple coating layers 32 are provided that contain compounds including, but not limited to, fertilizer nutrients, hormones, pesticides, herbicides, fungicides, antibacterial agents, and pigments. The plant growth promoting agents can be included together with an appropriate binder compound in a solution. Solvents such as water, ethanol, isopropyl alcohol, methanol, methylene chloride, acetone or combinations thereof and the like, can by used to dissolve components of the secondary growth augmentation layer. Typically, these are dissolved in a solvent with 20-60% material and 40-80% solvent. Any of the materials in the secondary coating should be able to perform its intended function without negatively affecting the seed.

These compounds are commercially available and their use and manufacture are well known in the art. Dry material or solutions of these compounds are often combined with an appropriate preferred binding agent such as the cellulose derivatives of methylcellulose, carboxymethylcellulose, hydroxymethycellulose, hydroxypropylcellulose, hydroxyethylmethylcellulose, hydroxypropylmethylcellulose, and the like. Other binders include polyvinyl alcohol, polyvinyl acetate, povidone, and copolyvidone. The binding agent serves to adhere the secondary layer 32 to the protective polymer coated seed or to facilitate individual layers binding to each other. It also prevents cracking and provides uniform surface. The concentration of the binder in solution will depend upon the components used and the desired viscosity of the coating. The growth enhancement agents can be applied as single components or as mixtures as needed. With some seed types or for different soil types, specific compounds may either be included or omitted due to the individual requirements that enhance germination and growth. These secondary layers 32 are intended to be readily water soluble to ensure that the constituent fertilizer nutrients and other compounds are washed from the seed into the soil by natural rainfall or irrigation, for utilization by the emerging seedling, or to prevent infection or rot of the seed and seedling. In addition, small amounts of drying agent enhancers such as lower molecular weight alcohols can be utilized in the composition. If desired, surfactants, emulsifiers, and preservatives may also be used at small levels, usually less than 0.5% by weight. These function to enhance the stability of the seed coatings. Preferred surfactants include, but are not limited to, lecithin, sodium lauryl sulfate, polysorbate 60, polysorbate 80, polyoxethylene polyoxpropylene block copolymers, or combinations thereof. In a preferred embodiment, pigments are included such as titanium dioxide, iron oxides, natural pigments, natural dyes, and the colorants FD&C, or D&C lakes. The pigments provide an easy way to determine when seeds have been coated. In cases where the seed coated surface is tacky, a glidant such as talc, colloidal silicon dioxide, steric acid, or combinations thereof may be added.

Primary nutrient fertilizers are commonly composed of chemical compounds that contain nitrogen (N), phosphorous (P), and potassium (K). Secondary nutrients often contain calcium (Ca), magnesium (mg), sulfur (S), boron (B), zinc (Zn), copper (Cu), and the like. These are available as either dry or liquid varieties. Common nitrogen fertilizers include ammonium nitrate, urea, ammonium phosphate, ammonium sulfate, urea phosphate, and ammonium molybdate, among others. Potassium may be obtained from potassium nitrate, potassium phosphate, potassium hydroxide, potassium sulfate, or potassium chloride. The secondary nutrients may be obtained from available sources of magnesium sulfate, calcium nitrate, sodium borate, magnesium nitrate, chelated complex of copper, calcium, iron, zinc, magnesium, manganese, and ammonium or sodium molybdate. In addition, other additives such as benzoic acid, salicylic acid, and similar derivatives are often part of fertilizer mixes. A variety of suitable sources and the methods of preparation of these and the secondary nutrient containing compounds are readily apparent to persons skilled in the art.

Herbicides are often employed to reduce unwanted plant species that compete with the desired crops being cultivated. In addition, undesired plant species often harbor insect pests or microbial diseases that target crop plants and reduce yield. Preferred herbicides may have specific or broad spectrums of activity on desired plant species and are commercially available and known to persons skilled in the art. These include glyphosate, dicamba, alachlor, metolachlor, oxabetrinil, thiocarbamate 5-ethyl-N,N-dipropyl-thiocarbamate, acetochlor, and like compounds. It is common agronomic practice to use various antidotal compounds to reduce phytotoxicity of some herbicides to different crops. These include fluorazole, cyometrinil, N,N-diallyl dichloroacetamide, and like compounds.

Fungicides, bactericides, insecticides/pesticides, and like agents, are also readily commercially available and their composition and use known to persons skilled in the art. Inorganic and organic copper and similar heavy metal compounds, either as salts or in heavy metal chelates, posses antifungal and antibacterial properties. Further effective compounds, are propenoic acids and oximine ethers and their substituted derivatives all of which have potent antimicrobial and insecticidal activities. These or similar compounds may be included in some embodiments of the present invention to reduce crop loss from disease or pests.

Crop yield has increased recently in what is termed as a green revolution. This is due to the development of high-yield crop varieties that can tolerate increased levels of fertilizer nutrients and herbicides. The use of increased levels of these compounds results in faster growth and more vigorous crops. It also allows the cultivation of poorer soil types more prone to erosion. An effect of these new crop varieties is the increasing use of fertilizer nutrients and herbicides. Despite the gain in crop yield there are deleterious side effects from these methods. Both of these types of compounds contribute to agricultural leaching and run-off of primarily nitrogen, phosphorous, and other chemical pollutants. Increased erosion is another problem since this reduces the fertility of the soil and thus leads to even heavier use of exogenous fertilizers. Elevated agricultural use of antimicrobial and insecticidal/pesticidal compounds also contributes to undesirable pollution of the environment via leaching and run-off.

The inclusion of nutrient fertilizers, herbicides, and antimicrobial or insecticidal/pesticidal agents, in the secondary coating layers 32 of seeds, allows the reduction of the absolute amounts of the compounds that are used. The growth enhancement agents act directly on the germinating seed and seedling and thus are more efficiently utilized, while the protective compounds limit growth of undesirable microbes or insects and their larva. This provides an alternative cost saving and environmentally sound method to increase crop vitality and yield.

Plant hormones can be included in amounts ranging from as little as 0.001% to as high as 1%. These are commercially available from a variety of sources and are known to persons skilled in the art. They include auxins, gibberellic acid, cytokinins, and the like. In addition, common natural and synthetic herbicides, pesticides, fungicides, and bactericides are commercially available and known to persons skilled in the art. These agents can be included in mixtures with fertilizer nutrients in the secondary growth-promoting layer 32.

The coating of the seed can be accomplished by many known methods using a fluid bed granulator (air-suspension apparatus) or rotary pan device, which are known in the art. Specific operational mechanical parameters will depend on seed type. When coating a seed with the protective polymer film coating it is important to have a completely dissolved and uniform polymer solution. The viscosity of the coating must be maintained at desired levels and the dew point set to approximately 10-20 cc. Ideal temperature ranges for the coating process are from about 25° C. to about 70° C. Typically, the majority of the coating is done in closed perforated pan system. This consists of a drum or, vessel of some kind, with an inserted spray gun apparatus at the center for spraying the coating material as a fine mist. The seeds or core elements to be coated are introduced into the cylindrical pan where they are made to tumble. The rotary motion tends to provide smooth uniform surfaces to the coated seeds, which facilitates additional protective coatings, or the secondary growth augmentation layer. Alternative devices use revolving drums placed on specific angles to regulate flow. In still other fluid bed granulator devices, air flow is used to suspend seeds/particles for coating. Typically, sensors are used to monitor rotational speed, airflow rate, temperature, dew point, and other parameters. In all cases, sterility of the equipment is essential. There are both dry and wet processes for making the first polymer protective film or secondary coatings for use in such machinery.

In the dry process, the coating suspension is prepared by weighing all ingredients into an appropriate container that has an attached blender. The mixture is blended until homogenous, typically for 5-10 minutes. The components are usually dry powders, but if one is a liquid it is added after homogenization of the dry components. The blended mixture can be dispersed into water, or other solvents, at about 25° C. to about 70° C. to make a liquid coating, typically having 5-30% solids content. The solvent is weighed into the vessel with a diameter about equal to the depth of the final solution suspension. A low sheer mixer, with a blade typically about one third the diameter of the vessel, is lowered into the water to vortex the water. The dry homogenous film polymer coating material is added. The speed and depth of the blade is adjusted to avoid foaming and having air drawn into the solution. The viscosity can range from 50-90 cP as measured on a commercial rotational viscosity-measuring instrument (viscometer). In the wet process, each ingredient is first dissolved in an appropriate solvent and then these are mixed similarly to the dry process, to form the protective film polymer or secondary coating.

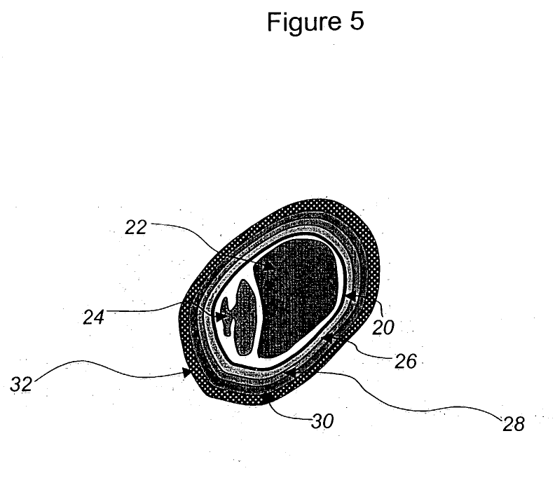

The protective first polymer layer 26 (FIG. 2), or layers 28, 30 (FIG. 3), and secondary growth-promoting layer 32 (FIG. 4; FIG. 5) can be sprayed onto the seeds in series. A variety of known processes for this can be employed. These include pneumatic, hydraulic, or hydrostatic spraying techniques. An important point is that lines must be kept free of aggregates and entrapped air. The design should reduce dead spaces, which contribute to flow problems. If not controlled these factors tend to increase undesirable foaming and result in poor coating quality. The temperature and pressure of the compound being sprayed depends on the exact material selected and the viscosity of it in the liquid form. The coating is atomized through a spray nozzle and is deposited onto the seed in thin layers 26, 28, 30, 32. It is desirable that each layer dries before additional layers are applied. The time required for the drying process is primarily dependant on the specific materials used in the coatings, the solvents used to solubilize component materials, and the inclusion of drying agents. Airflow, temperature, and the rotation speed of the pan drum can be adjusted to further regulate the drying process, depending on the specific machinery used. In the case of the first protective polymer layer 26, the thickness may be increased to obtain desired protective properties or hygroscopic characteristics. Alternatively, as shown in FIG. 3, the protective layer may be comprised of multiple thin coatings of the polymer to produce the protective layers 26, 28, 30. Application of the multiple thin layers can be used to add thickness to a desired level, while maintaining an even, and uniform coating. The spray should be such that the layer is homogeneous and the seeds do not form aggregates by sticking together. Regulation of the air and seed flow can accomplish this and will vary somewhat depending on the seed weight, size, and shape. The temperature must also be controlled so that the coating material maintains the ideal viscosity, but should not exceed 120° C. to prevent damage to the seed, and is ideally from about 25° C. to about 70° C. If the temperature is excessively elevated for any length of time the seed viability will be dramatically reduced. Care should also be taken to maintain sufficient temperature that seed aggregates do not form, which may occur at lower temperatures, usually below specific temperatures depending on the precise material used.

### EXAMPLE

Coated seeds comprising a first protective polymer film coating selected from the ingredients listed in Table 1, and a secondary growth augmentation coating selected from the ingredients listed in Table 2 were prepared according to the following percentages by weight.

TABLE 1

| | |
|---|---|
| Primary Polymer (CAP/other) | 30-90% |
| Secondary Polymers | 0-45% |
| Plasticizers | 0-35% |
| Binders | 0-35% |
| Surfactants | 0-20% |
| Glidants | 0-15% |
| Pigments | 0-1% |

TABLE 2

| | |
|---|---|
| Primary Nutrients | 0-60% |
| Secondary Nutrients | 0-5% |
| Hormones | 0-1% |
| Insecticides/Pesticides | 0-25% |
| Herbicides | 0-25% |
| Fungicides | 0-25% |
| Bactericides | 0-25% |
| Pigments | 0-1% |
| Binders | 0-30% |
| Surfactants | 0-20% |
| Glidants | 0-20% |

It is to be understood that the foregoing description comprises a preferred embodiment of the present invention. It should be apparent to those of skill in the art that certain advantages have been achieved; it should also be apparent to those of skill in the art that various modifications, adaptations, and alternative embodiments thereof may be made within the scope and spirit of the present invention. Accordingly, the present invention is further defined by the following claims.

What is claimed is:

1. A seed coating composition comprising a first protective polymer film coating and a secondary growth augmentation coating, wherein the first protective polymer film coating is non-phytotoxic, maintains oxygen exchange properties, and is hygroscopic.

2. The seed coating composition of claim 1, wherein the first protective polymer film is selected from the group consisting of primary polymers, secondary polymers, plasticizers, binders, surfactants, glidants and pigments.

3. The seed coating composition of claim 1, wherein the secondary growth augmentation coating is selected from the group consisting of primary nutrients, secondary nutrients, hormones, insecticides, pesticides, herbicides, fungicides, bactericides, pigments, binders, surfactants and glidants.

4. The seed coating composition of claim 1, wherein the first protective polymer film coating is selected from the group consisting of cellulose acetate phthalate, hydroxypropylcellulose phthalate, hydroxyethylmethylcellulose phthalate, hydroxypropylmethylcellulose phthalate, hydroxymethylcellulose phthalate, carboxymethylcellulose phthalate, methylcellulose phthalate, polyvinyl acetate phthalate, polyvinylpyrrolidone, and polyvinylmethylethermaleic anhydride copolymer.

5. The seed coating composition of claim 2, wherein the plasticizer is selected from the group consisting of phthalate, acetyltriethyl citrate, triethyl citrate, acetyltributyl citrate, dibutylsebacate, triacetin, glyceryl triacetate, polyethylene glycol, propylene glycol, and glycerin.

6. The seed coating composition of claim 2, wherein the binder is selected from the group consisting of methylcellulose, carboxymethylcellulose, hydroxymethylcellulose, hydroxypropylcellulose, hydroxyethylmethylcellulose, hydroxypropylmethylcellulose, polyvinyl alcohol, polyvinyl acetate, povidone, and copolyvidone.

7. The seed coating composition of claim 2, wherein the surfactant is selected from the group consisting of lecithin, sodium lauryl sulfate, polysorbate 60, polysorbate 80, polyoxethylene polyoxpropylene block copolymers, and combinations thereof.

8. The seed coating composition of claim 2, wherein the pigment is selected from the group consisting of titanium dioxide, iron oxide, natural pigments, natural dyes, FD&C colorants, and D&C lakes.

9. The seed coating composition of claim 2, wherein the glidant is selected from the group consisting of talc, colloidal silicon dioxide, steric acid, and combinations thereof.

10. The seed coating composition of claim 3, wherein the primary nutrient is selected from the group consisting of ammonium nitrate, urea, ammonium phosphate, ammonium sulfate, urea phosphate, and ammonium molybdate, potassium nitrate, potassium phosphate, potassium hydroxide, potassium sulfate, and potassium chloride.

11. The seed coating composition of claim 3, wherein the secondary nutrient is selected from the group consisting of magnesium sulfate, calcium nitrate, sodium borate, magnesium nitrate, chelated complex of copper, calcium, iron, zinc, magnesium, manganese, ammonium molybdate, sodium molybdate, benzoic acid, and salicylic acid.

12. The seed coating composition of claim 3, wherein the herbicide is selected from the group consisting of glyphosate, dicamba, alachlor, metolachlor, oxabetrinil, thiocarbamate 5-ethyl-N,N-dipropyl-thiocarbamate and acetochlor.

13. The seed coating composition of claim 12, further comprising an antidotal compound selected from the group consisting of fluorazole, cyometrinil, and N,N-diallyl dichloroacetamide.

14. The seed coating composition of claim 3, wherein the fungicide, bactericide, insecticide and pesticide are selected from the group consisting of inorganic copper, organic copper, heavy metal compounds, propenoic acids, oximine ethers, and substituted oximine ethers.

15. The seed coating composition of claim 3, wherein the plant hormone is selected from the group consisting of auxins, gibberellic acid, and cytokinins.

16. A method of coating seeds, the method comprising the steps of:
(a) coating a quantity of seeds with a first protective polymer film coating;
(b) allowing the first protective polymer film coating to dry; and
(c) coating the quantity of seeds with a secondary growth augmentation coating.
